(19) United States
(12) Patent Application Publication
(10) Pub. No.: US 2009/0094668 A1
(43) Pub. Date: Apr. 9, 2009

(54) EMAIL PRIVACY SYSTEM AND METHOD

(75) Inventors: George E. Corbin, Hyde Park, NY (US); Walter B. Farrell, Woodstock, NY (US); Anthony S. Grech, Beacon, NY (US); Thomas E. Murphy, JR., Hopewell Junction, NY (US); Jeffrey S. Stevens, Rochester, MN (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/868,695

(22) Filed: Oct. 8, 2007

(51) Int. Cl. G06F 21/00

(52) U.S. Cl. 726/1

(57) ABSTRACT

A method of protecting identity privacy of a recipient of an electronic mail message from a sender to the recipient is disclosed. The method includes identifying a privacy policy within an address book entry corresponding to the recipient within an address book associated with the sender. The method further includes sending the electronic mail message from the sender to the recipient via a network in accordance with the identified privacy policy.

### BACKGROUND OF THE INVENTION

1. Field of the Invention

This invention relates generally to electronic mail, and more particularly to electronic mail address book entries.

2. Description of Background

Electronic mail (email) has become a convenient and widespread means for communication, particularly for communication with large groups of people. Many email communication software applications, also known as “email clients”, incorporate electronic address books that include an email address of individuals within the address book, and may allow for creation of groups of individuals.

A composer or sender of an email message has means to hide an email address, and thus the identity of a private recipient (or recipients) of the message from other recipients of the same message by designating the private recipient (or recipients) as receiving what is known as a blind carbon copy (bcc). However, the use of address book groups of individuals, as well as oversight of the composer of the email message, can result in an inadvertent inclusion of private recipients within normal messaging address fields, thereby providing to other recipients the email address and/or identity of the private recipients.

For example, a company may include diverse clients to which it sells many products and maintains business relationships via email. While it is important that business matters of these clients are kept separate, the identity of clients may also need to be kept private. For instance, email delivery of a newsletter from a business to clients or patrons can lead to disclosure of the identities of the clients or patrons via their email addresses if the message is not composed and delivered via use of a bcc address field. Accordingly, there is a need in the art for an electronic mail arrangement that overcomes these drawbacks.

### SUMMARY OF THE INVENTION

An embodiment of the invention provides a method of protecting identity privacy of a recipient of an electronic mail message from a sender to the recipient. The method includes identifying a privacy policy within an address book entry corresponding to the recipient within an address book associated with the sender. The method further includes sending the electronic mail message from the sender to the recipient via a network in accordance with the identified privacy policy.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that recognizes and responds to address book attributes related the requested privacy of the private recipient, and ensures that a composer of the email message does not inadvertently send the message in a manner that compromises the requested privacy.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a schematic block diagram of one example of an infrastructure for operation of an electronic mail identity privacy protection arrangement.

FIG. 2 illustrates one example of a user interface for composing an electronic mail message in accordance with an embodiment of the invention.

FIG. 3 illustrates one example of an electronic mail header that includes a user defined privacy tag in accordance with an embodiment of the invention.

FIG. 4 illustrates one example of a user interface for viewing an electronic mail message in accordance with an embodiment of the invention.

FIG. 5 illustrates one example of a user interface for composing an electronic mail message in accordance with an embodiment of the invention.

FIG. 6 illustrates one example of an address book user interface in accordance with an embodiment of the invention.

FIG. 7 illustrates a process flowchart of an exemplary method for protecting identity privacy of an electronic mail message in accordance with an embodiment of the invention.

The detailed description explains the preferred embodiments of the invention, together with advantages and features, by way of example with reference to the drawings.

### DETAILED DESCRIPTION OF THE INVENTION

An embodiment of the invention provides an email address book having entries that include privacy attributes. The attributes can be applied on an individual entry or collectively to all entries within a particular address book. Further embodiments include an email software application that is responsive to the privacy attributes of an entry within the address book to prevent inadvertent disclosure of an identity of the entry to recipients of a message sent by a composer of the message to multiple recipients.

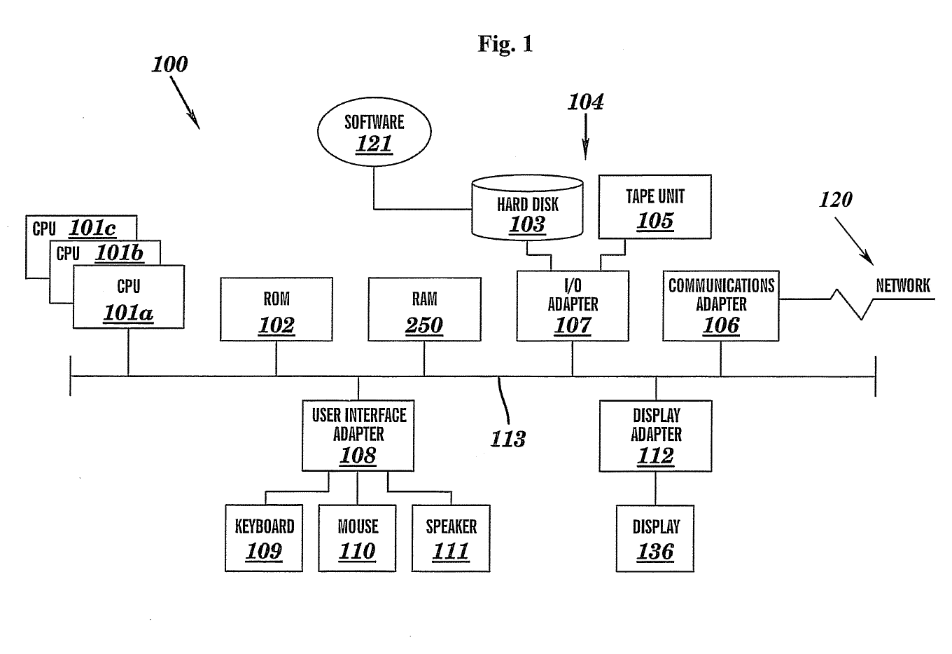

FIG. 1 depicts an embodiment of a processing system 100 for implementing the teachings herein. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 120 enabling data processing system 100 to communicate with other such systems. Display monitor 136 is connected to system bus 113 by display adapter 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Embodiments of the network 120 are contemplated to include external connections, such as via the Internet for example, as well as other networking environments that may be connected via either wired or wireless connections, such as an intranet and an extranet, for example.

As disclosed herein, the system 100 includes machine readable instructions stored on machine-readable media (for example, mass storage 104) for storing address book entries for use with an email-messaging program. As referred to herein, the instructions are referred to as “email software” 121. The software 121 may be produced using software development tools as are known in the art. Embodiments of the system 100 are contemplated to include email clients and servers for example.

Address books included with email software 121 are not currently tied to any particular standard, and therefore, addition of new attributes are not proscribed by present design standards. As such, the address book entry attributes described herein are contemplated to be applicable to any email software 121, including current email software applications 121.

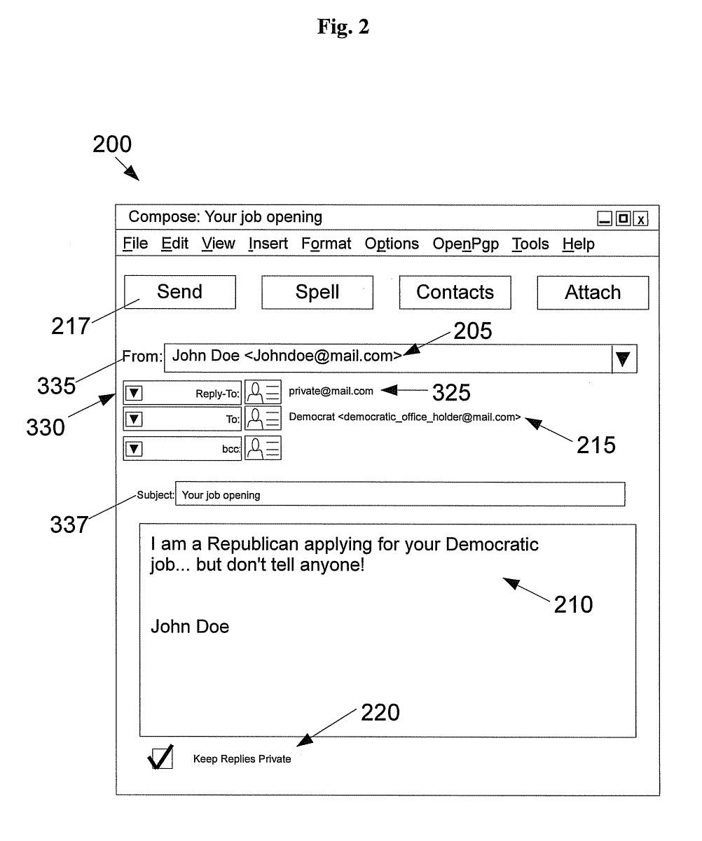

FIG. 2 depicts one embodiment of a user interface (UI) 200 of email software 121. The UI 200 of FIG. 2 indicates a compose window 200, which is used for the writing and sending of email messages. In one embodiment, a sender 205 of a first email message 210 explicitly communicates a request that a recipient 215 of the email message 210 recognize the request to preserve identity privacy. One example of identity privacy is to avoid disclosure of the email address of the sender 205 within any subsequent email messages that originate from the recipient 215 to groups of other individuals that include the sender 205. In one embodiment, prior to pressing a send button 217, and thereby sending the message 210 to the recipient 215, the sender 205 indicates the request to maintain identity privacy via a privacy selection 220, such as an explicit privacy selection checkbox 220. While an embodiment has been depicted herein as a privacy selection including the checkbox 220, it will be appreciated that the scope of the invention is not so limited, and may include other means to designate a request to maintain identity privacy.

Within internetworking and computer network engineering, Request for Comments (RFC) documents are a series of memoranda encompassing new research, innovations, and methodologies applicable to Internet technologies. Through the Internet Society, engineers and computer scientists may publish discourse in the form of an RFC memorandum, either for peer review or simply to convey new concepts and information. The Internet Engineering Task Force (IETF) adopts some of the proposals published in RFCs as Internet standards. As relate to electronic mail, the main standards are “Post Office Protocol” (RFC 1939) and “Simple Mail Transport Protocol” (RFC 2821), which describe how to receive and send email over the Internet. In addition, “Internet Text Messages” (RFC 2822) describes the payload in the email. The contents of “Post Office Protocol” (RFC 1939), “Simple Mail Transport Protocol” (RFC 2821), and “Internet Text Messages” (RFC 2822) are herein incorporated by reference in their entirety.

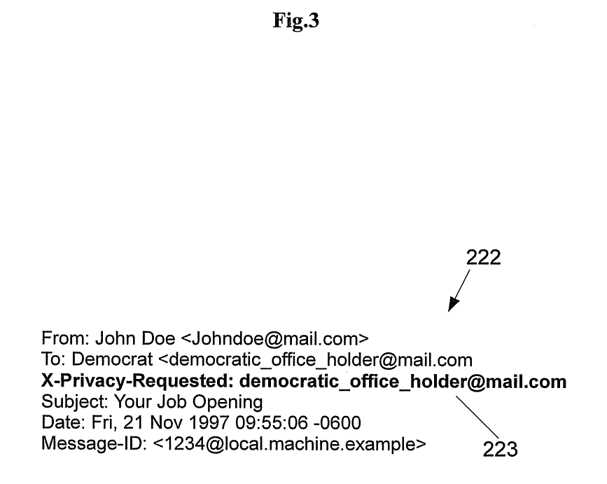

In an embodiment, selection of the checkbox 220 develops a user defined header in accordance with “header extensions” as described within RFC 2822. FIG. 3 depicts an example of a header 222 that includes a user defined privacy tag 223 in accordance with “header extensions” described within RFC 2822. The email software 121 is responsive to reception of the first email message 210 that includes the user defined privacy tag 223 to perform processing of information regarding the request for identity privacy by the sender 205. The email software 121 processes the information for incorporation within an address book and distribution lists of subsequent email messages, as will be described further below.

Utilization of the user defined privacy tag 223 in accordance with RFC 2822 allows software 121 to be heterogeneous with respect to various systems 100. For example, software 121 responds to the request for identity privacy via various systems 100 that recognize and conform to use of header 222 extensions in accordance with RFC 2822. Further, as defined by RFC 2822, systems that are RFC 2822 compliant shall ignore user defined headers 223 to which they are not responsive. Accordingly, incorporation of the user defined privacy tag 223 has no adverse effect on any other RFC 2822 compliant system 100, such as an email client or server for example, which does not implement the electronic mail arrangement described herein.

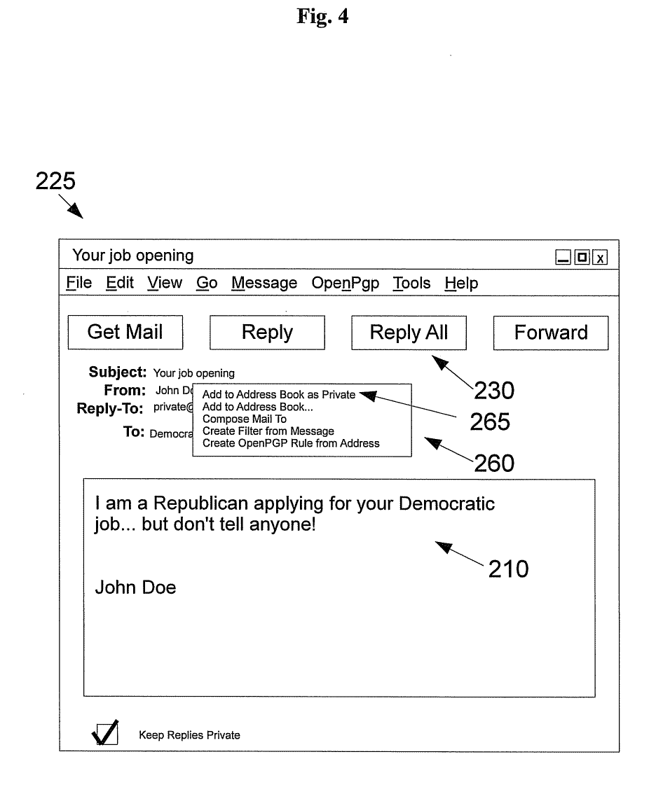

FIG. 4 depicts another embodiment of a UI 225 of email software 121, such as a viewing window 225 displayed upon the display 136 of the system 100 of the recipient 215. That is, the viewing window 225 represents the display of the email message 210 after it has been sent by the sender 205 and received by the recipient 215. In response to a subsequent message composed by the recipient 215 in reply to the email message 210, such as by selecting a Reply All button 230, the email software 121 will recognize the privacy selection 220, and be responsive to protect the identity privacy of the sender 205.

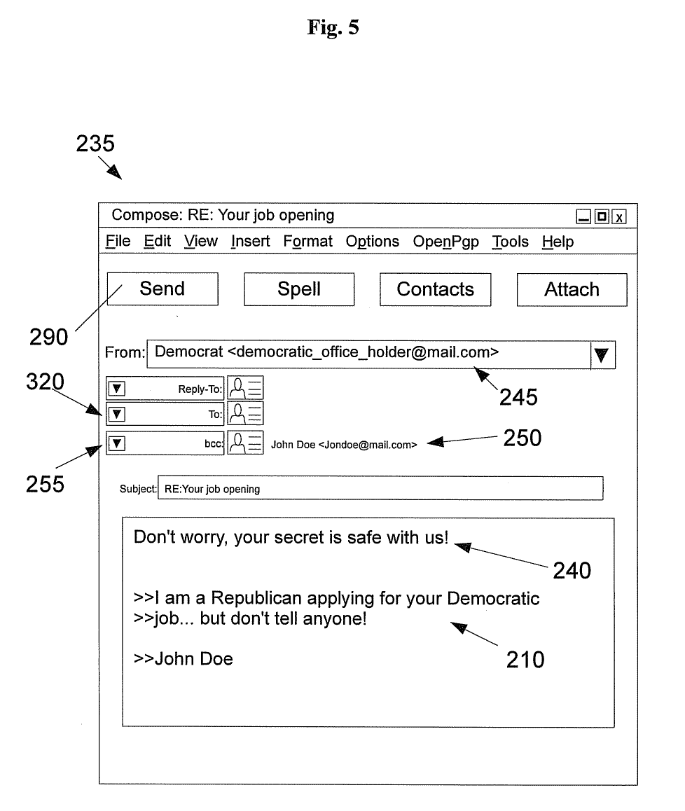

FIG. 5 depicts an example of another UI 235, such as another compose window 235 for example, that is generated in response to selection of the Reply All button 230 described above. Compose window 235 allows creation of a second email message 240 in reply to the first email message 210. It will be appreciated that recipient 215 of the first email message 210 (in FIG. 1) is now the sender 245 of the second message 240 in reply to the first message 210. Likewise, sender 205 of the first message 210 is now a recipient 250 of the second message 240. In one embodiment, the software 121 is responsive to the privacy selection 220 to automatically protect the identity privacy of the recipient 250 by inserting the email address of the recipient within a bcc address field 255.

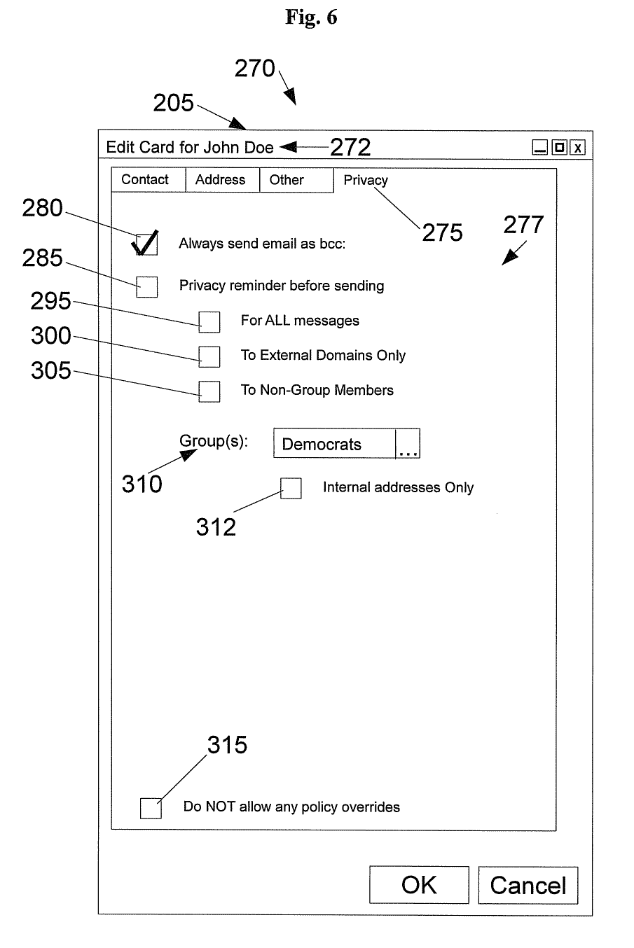

With reference to FIG. 4, in response to a selection such as a right-click for example by the recipient 215 of the first message 210, a dialog box 260 is opened. Dialog box 260 includes context-sensitive options related to the specific selection. For example, software 121 is responsive to selection of an Add to Address Book as Private entry 265 to open an Address Book Dialog Box 270 (shown in FIG. 6), corresponding to an Address Book entry 272 for the sender 205 of the first message 210.

Referring now to FIGS. 5 and 6, a privacy tab 275 of the Address book dialog box 270 is selected, such that the dialog box 270 indicates a number of possible privacy attributes or policies 277 that may be associated with the sender 205 of the first message 210. The software 121 is responsive to selection of the checkbox 220 to automatically select one or more privacy policies 277 that will be associated with the address book entry 272 for the sender 205 to thereby protect the identity privacy of the sender 205.

For example, the software 121 is responsive to selection of an always send bcc selection box 280, to automatically insert the email address of the address book entry 272 (such as the sender 205 of the first message 210) into the bcc address field 255 of the compose window 235 of any subsequent email message, such as the second email message 240 that includes the sender 205 as a recipient 250. The software 121 is also responsive to selection of a reminder selection box 285 to provide a reminder to the sender 245 of a subsequent email message to the recipient 250 that is within the address book via address book entry 272, such as a confirmation dialog in response to the sender 245 pressing a send button 290, but before sending the message 240. Furthermore, the software 121 is responsive to selection of an ALL Messages selection box 295 to provide the reminder prior to the sending of all email messages. Alternatively, in response to the selection of an External Domains selection box 300, the software 121 provides the reminder only prior to sending of email messages that are external to an email domain to which at least one of the sender 245 and the recipient 250 belongs. Further, the software 121 is responsive to selection of a To Non-Group Members selection box 305 to provide the reminder to the sender 245 prior to the sending of the second email message 240 to any recipient who is not a member of a group in which the recipient 250 (via the address book entry 272) is designated. A group dialog 310 provides for designation of the recipient 250 into one or more groups to which its identity may be revealed, and an internal only checkbox 312 requires that only internal email addresses are part of any of the designated groups into which the recipient 250 (via the address book entry 272) is designated. In response to a Do not allow overrides selection box 315, the software 121 is responsive to prevent any action by the sender 245 contrary to the selected privacy policies 277, such as to copy the email address of the address book entry 272 into a to: address field 320, for example.

As described above, address books are not currently tied to a particular standard. As such, it is contemplated that in order to be responsive to the privacy selection 220 to automatically select one or more privacy policies 277 associated with the address book entry 272, the viewing window 225 and compose window 235 that operate as part of software 121 have been specifically configured for operation with the compose window 200 that includes the privacy selection 220.

With reference now to FIGS. 2 through 6, in another embodiment the software 121 with which the viewing window 225, compose window 235, and address book dialog 270 are associated infers the request by the sender 205 of the first email message 210 to preserve identity privacy via use of standard email message fields within an email message, such as the first email message 210 sent by the sender 205 to the recipient 215. As one example, the software 121 is responsive to an email address 325 within a Reply-To: field 330 that differs from the sender 205 email address in a From: field 335, to infer that the sender 205 requests identity privacy. As another example, the software 121 is responsive to receipt of the email message that includes a keyword, such as the email address 325 that includes a keyword, or a subject field 337 that includes a keyword, such as “private” to indicate that the sender 205 requests identity privacy. As such, the software 121 with which the viewing window 225, compose window 235, and address book dialog 270 are associated can be responsive to infer the request for identity privacy in conjunction with the compose window 200 that does not include the explicit privacy selection 220.

It will be appreciated that the software 121 with which the viewing window 225, compose window 235, and address book dialog 270 are associated shall be responsive to the inference that the sender 205 requests identity privacy to incorporate any of the privacy policies 277 described herein into the address book entry 272 that corresponds to the sender 205 of the first message 210.

In view of the foregoing, and with reference to the compose window 235 of FIG. 5, it will be appreciated that the software 121 executing on the processor 101 performs a method that facilitates protecting the identity privacy, such as the email address, of the recipient 250 of the second electronic mail message 240 from the sender 240 to the recipient 250.

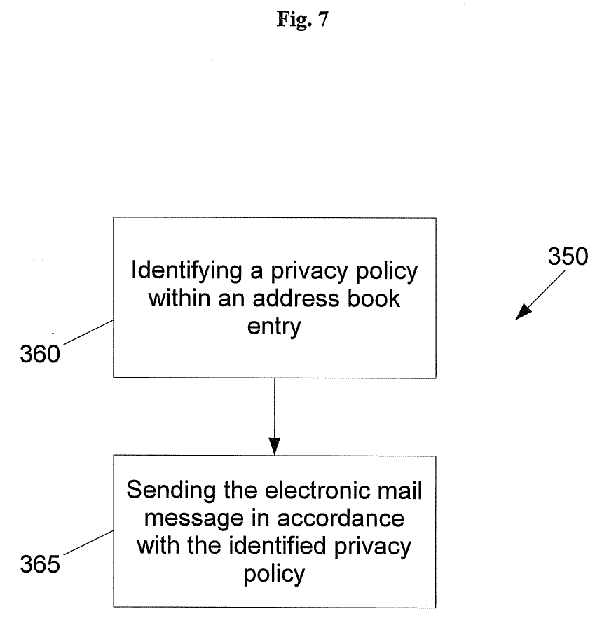

FIG. 7, in conjunction with FIGS. 1 through 6, depicts a flowchart 350 of an exemplary process performed by the software 121 executing on the processor 101 to protect the identity privacy of the recipient 250 of the second electronic mail message 240 that has been sent from the sender 245. The process begins at block 360 by identifying at least one privacy policy from the privacy polices 277 displayed within the address book entry 272 of the address book dialog 270 that corresponds to the recipient 250 (sender 205) and is associated with and accessible to the sender 245. The process further includes sending, at block 365, the second electronic mail message 240 from the sender 245 to the recipient 250 via the network 120 in accordance with the identified privacy policy 277.

In an embodiment, the process further includes determining the request for identity privacy based upon a previous electronic mail message, such as the first electronic mail message 210 that has been received by the sender 245 of the second email message 240 from the recipient 250 of the second email message 240. A further embodiment of the process includes determining the request for identity privacy based upon the previous electronic mail message 210 by inferring the request for identity privacy based upon at least one of a difference between the From: address field 335 and the Reply-to: address field 330 of the previous electronic mail message 210, and a keyword within the previous electronic mail message 210, such as within at least one of the Reply-to: address field 330 and the subject field 337.

The privacy policy 277 is identified via selection of at least one of the always send bcc: selection box 280 for sending the electronic mail message 240 with the email address of the recipient 250 within the bcc: address field 255, and selection of the reminder selection box 285 for reminding the sender 245 of the determined for identity privacy. The selection of the reminder selection box 285 may further include selection of at least one of the all messages selection box 295 for reminding the sender 245 before sending the second electronic mail message 240, and the external domains selection box 300 for reminding the sender 245 before sending the second electronic mail message 240 to one or more email addresses associated with a domain that is different from at least one of the domain associated with the email address of the recipient 250 and the domain associated with the email address of the sender 245. The method may further include defining, via the group dialog 310, a group of one or more email addresses associated with the email address of the recipient 250. Following defining the group having one or more email addresses, the software 121 may remind the sender 245 before sending the second electronic mail message 240 to one or more email addresses within the group defined via group dialog 310 that is different from at least one of the domain associated with the email address of the recipient 250 and the domain associated with the email address of the sender 245.

While exemplary embodiments of the invention have been described having processing systems 100 including email clients and servers, it will be appreciated that the scope of the disclosure herein is not so limited, and is contemplated to include other processing systems capable to compose, send, and receive electronic mail messages, such as personal digital assistants (PDAs), cellular telephones, and Internet or World Wide Web based email systems, for example.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of protecting identity privacy of a recipient of an electronic mail message from a sender to the recipient, the method comprising:
identifying a privacy policy within an address book entry corresponding to the recipient, the address book entry within an address book associated with the sender; and
sending the electronic mail message from the sender to the recipient via a network in accordance with the identified privacy policy.

2. The method of claim 1, further comprising:
determining a request for identity privacy within the address book entry based upon a previous electronic mail message received by the sender from the recipient.

3. The method of claim 2, wherein the determining comprises:
inferring the request for identity privacy based upon at least one of:
a difference in a From: address field and a Reply-to: address field of the previous electronic mail message;
a keyword within the previous electronic mail message; or
a combination thereof.

4. The method of claim 1, wherein the identified privacy policy comprises at least one of:
sending the electronic mail message with an email address of the recipient within a bcc: address field;
reminding the sender of the determined request for identity privacy; or
a combination thereof.

5. The method of claim 4, wherein the reminding comprises:
reminding the sender before sending the electronic mail message.

6. The method of claim 1, further comprising:
defining a group of one or more email addresses associated with an email address of the recipient.

7. The method of claim 6, wherein the identified privacy policy comprises:
reminding the sender before sending the electronic mail message to one or more email addresses that are not within the defined group.

8. The method of claim 6, wherein the identified privacy policy comprises:
reminding the sender before sending the electronic mail message to one or more email addresses within the defined group that are associated with a domain that is different from a domain associated with the email address of the recipient.

9. The method of claim 6, wherein the identified privacy policy comprises:
reminding the sender before sending the electronic mail message to one or more email addresses within the defined group that are associated with a domain that is different from a domain associated with an email address of the sender.

10. A computer program product stored on computer readable media and comprising computer executable instructions for protecting identity privacy of a recipient of an electronic mail message from a sender to the recipient, the product comprising instructions for:
determining a request for identity privacy within an address book entry corresponding to the recipient, the address book entry within an address book associated with the sender;
identifying a privacy policy within an address book entry corresponding to the recipient, the address book entry within an address book associated with the sender; and
sending the electronic mail message from the sender to the recipient via a network in accordance with the identified privacy policy.

11. The computer program product of claim 10, wherein the instructions comprise:
determining a request for identity privacy within the address book entry based upon a previous electronic mail message received by the sender from the recipient.

12. The computer program product of claim 11, wherein the determining comprises:
inferring the request for identity privacy based upon at least one of:
a difference in a From: address field and a Reply-to: address field of the previous electronic mail message;
a keyword within the previous electronic mail message; or
a combination thereof.

13. The computer program product of claim 10, wherein the identified privacy policy comprises at least one of:
sending the electronic mail message with an email address of the recipient within a bcc: address field;
reminding the sender of the determined request for identity privacy; or
a combination thereof.

14. The computer program product of claim 13, wherein the reminding comprises:
reminding the sender before sending the electronic mail message.

15. The computer program product of claim 10, further comprising instructions for:
defining a group of one or more email addresses associated with an email address of the recipient.

16. The computer program product of claim 15, wherein the identified privacy policy comprises:
reminding the sender before sending the electronic mail message to one or more email addresses that are not within the defined group.

17. The computer program product of claim 15, wherein the identified privacy policy comprises:
reminding the sender before sending the electronic mail message to one or more email addresses within the defined group that are associated with a domain that is different from a domain associated with the email address of the recipient.

18. The computer program product of claim 15, wherein the identified privacy policy comprises:
reminding the sender before sending the electronic mail message to one or more email addresses within the defined group that are associated with a domain that is different from a domain associated with an email address of the sender.

19. A system comprising:
processing, display, storage, input and output resources for executing machine readable instructions stored in the storage; the machine readable instructions for protecting identity privacy of a recipient of an electronic mail message from a sender to the recipient by instructions for:
identifying a privacy policy within an address book entry corresponding to the recipient, the address book entry within an address book associated with the sender; and
sending the electronic mail message from the sender to the recipient via a network in accordance with the identified privacy policy.

20. The system of claim 19, the machine readable instructions further comprising instructions for determining a request for identity privacy within the address book entry based upon a previous electronic mail message received by the sender from the recipient.
